(19) United States
(12) Patent Application Publication
(10) Pub. No.: US 2009/0259796 A1
(43) Pub. Date: Oct. 15, 2009

(54) DATA WRITING METHOD FOR NON-VOLATILE MEMORY AND STORAGE SYSTEM AND CONTROLLER USING THE SAME

(75) Inventors: Chee-Kong Awyong, Miaoli (TW); Chung-Hsun Ma, Miaoli (TW)

Correspondence Address: J C PATENTS, 4 VENTURE, SUITE 250, IRVINE, CA, 92618, US

(73) Assignee: PHISON ELECTRONICS CORP., Miaoli (TW)

(21) Appl. No.: 12/173,223

(22) Filed: Jul. 15, 2008

(30) Foreign Application Priority Data
Apr. 10, 2008 (TW) 97113033

(51) Int. Cl. G06F 12/00

(52) U.S. Cl. 711/102; 711/E12.001

(57) ABSTRACT

A data writing method for a non-volatile memory and a storage system and a controller using the same are provided. The data writing method includes executing a non-volatile memory writing program pre-stored in the non-volatile memory on a host, managing data desired to be written through the non-volatile memory writing program, executing a write-enabling command to temporarily disable a write protection of the non-volatile memory and executing a write command through the non-volatile memory writing program to write the data in a writing unit not recorded with any data in the non-volatile memory, and re-enabling the write protection after completing the writing by executing a write-protecting command. Accordingly, it is possible to avoid damage to the non-volatile memory due to multiple writings which are not desired in the non-volatile memory.

### CROSS-REFERENCE TO RELATED APPLICATION

This application claims the priority benefit of Taiwan application serial no. 97113033, filed on Apr. 10, 2008. The entirety of the above-mentioned patent application is hereby incorporated by reference herein and made a part of this specification.

### BACKGROUND

1. Technology Field

The present invention relates to a data writing method, and particularly to a data writing method for a non-volatile memory and a storage system and a controller using the same.

2. Description of Related Art

As digital cameras, mobile phones and MP3s equipped with a photographing function and MP4s have all developed rapidly in recent years, demands from consumers for various storage media also surge. In view of all the storage media presently available, the non-volatile memory (e.g., flash memory) with its features of non-volatility, power-saving, compact size and no mechanical structure are considered most adapted to being built inside of the foregoing portable multi-media devices. As a result, the market demand for flash memories has been burgeoning.

Generally, when the portable (removable) storage device having a flash memory as its storage medium is coupled to a host system, the host system would take the storage device as an exterior disk and perform repetitive accessing directly on the exterior disk through a file managing system of the host system. Since data in this type of storage medium may be easily changed, the storage medium is not suitable for storing data that are meant to be exclusive or permanent. For example, a system manufacturer may need to provide a firmware code of a device for the client to update the device. The system manufacturer would wish to use a storage medium which can only be written once to record such firmware code so that the firmware code will not be tampered with by unknown persons and thereby destroying the system. Hence, if a set of special writing procedures are developed so that a flash memory originally designed to be written and erased repeatedly can only be “written once”, application of the flash memory may be further expanded.

Furthermore, during the process of manufacturing flash memories, defective flash memories which can only be written for few times may be produced due to process factors. As mentioned above, given that a certain demand still exists for read-only flash memories, if a set of special writing procedures are developed to limit a number of times the defective flash memory can be written, those defective flash memories can be fully utilized to increase a yield on the flash memory.

### SUMMARY

The present invention is directed to a non-volatile memory storage system. The non-volatile memory storage system performs a data writing procedure which avoids causing damage to the non-volatile memory due to multiple writings.

The present invention is directed to a controller. The controller performs a data writing procedure which avoids causing damage to the non-volatile memory due to multiple writings.

The present invention is directed to a data writing method. The data writing method avoids causing damage to the non-volatile memory due to multiple writings.

The present invention is directed to a data writing method adapted to a non-volatile memory having a plurality of writing units. The data writing method includes performing a non-volatile writing program in a host. Moreover, data to be written to the non-volatile memory is written through the non-volatile memory writing program. The data writing method also includes performing a write-enabling command to temporarily disable the write protection of the non-volatile memory and performing a write command through the non-volatile memory writing program to write data desired to be written to the writing units not yet recorded with data in the non-volatile memory from the host in a unit of one writing unit. Finally, after the writing is completed, a write-protecting command is performed through the non-volatile memory writing program to enable the write protection for the non-volatile memory.

According to an embodiment of the present invention, each of the writing units can only be written once.

According to an embodiment of the present invention, the data writing method further includes recording writing counts for the writing units and determining whether the writing count for each writing unit is less than a predetermined threshold value, wherein the data is written only to the writing unit having the writing count less than the predetermined threshold value.

According to an embodiment of the present invention, the foregoing writing unit is a sector, a page or a block.

According to an embodiment of the present invention, the data writing method further includes performing an erase command through the non-volatile memory writing program to erase all the data recorded in the non-volatile memory.

According to an embodiment of the present invention, the foregoing step of managing the data desired to be written to the non-volatile memory includes performing at least one of a collecting operation and an aligning operation on the data.

The present invention is directed to a non-volatile memory storage system including a transmission interface for connecting to a host, a non-volatile memory, a non-volatile memory writing program and a controller. The non-volatile memory has a plurality of writing units for storing data. The non-volatile memory writing program is executed through the host to perform a plurality of data writing steps. The controller is coupled to the transmission interface and the non-volatile memory to initialize and execute a write protection of the non-volatile memory, to identify a write-enabling command of the non-volatile memory writing program so as to disable the write protection and identify a write-protecting command of the non-volatile memory writing program to enable the write protection of the non-volatile memory. The data writing steps include managing the data desired to be written to the non-volatile memory, executing the write-enabling command, executing the write command to write the data into the writing units not yet recorded with data in a unit of one writing unit, and executing the write-protecting command.

According to an embodiment of the present invention, each of the foregoing writing units can only be written once.

According to an embodiment of the present invention, the foregoing data writing steps further include recording writing counts for the writing units and determining whether the writing count for each writing unit is less than a predetermined threshold value, wherein the data is written only to the writing unit having the writing count less than the predetermined threshold value.

According to an embodiment of the present invention, the writing unit is a sector, a page or a block.

According to an embodiment of the present invention, the foregoing data writing steps further include performing an erase command through the non-volatile memory to erase all the data recorded in the non-volatile memory.

According to an embodiment of the present invention, the non-volatile memory writing program is stored in the non-volatile memory.

According to an embodiment of the present invention, the non-volatile memory is a flash memory.

According to an embodiment of the present invention, the transmission interface is a PCI Express interface, a USB interface, an IEEE 1394 interface, a SATA interface, an MS interface, an MMC interface, an SD interface, a CF interface or an IDE interface.

According to an embodiment of the present invention, the non-volatile memory writing program is stored in an independent partition of the non-volatile memory.

According to an embodiment of the present invention, the foregoing step of managing the data desired to be written to the non-volatile memory includes performing at least one of a collecting operation and an aligning operation on the data.

The present invention provides a controller adapted to a storage system having a non-volatile memory. The non-volatile memory has a plurality of writing units. The controller includes a non-volatile memory interface, a micro-processor unit and a write-protecting module. The micro-processor unit is used for identifying a write-enabling command and a write-protecting command of the non-volatile memory writing program. The non-volatile memory interface is coupled to the micro-processor unit and used for accessing the non-volatile memory. The write-protecting module is coupled to the micro-processor unit and used for initializing and executing the write protection to prevent any writing operation in the non-volatile memory, temporarily disabling the write protection according to the write-enabling command, and enabling the write protection of the non-volatile memory according to the write-protecting command. The host connected to the storage system executes the non-volatile memory writing program to perform a plurality of data writing steps. The data writing steps include managing the data to be written to the non-volatile memory, executing a write-enabling command and executing a write command to write the data from the host to the writing units not yet recorded with data in the non-volatile memory in a unit of one writing unit through the micro-processor unit and the non-volatile memory interface and executing the write-protecting command.

According to an embodiment of the present invention, each of the foregoing writing units can only be written once.

According to an embodiment of the present invention, the foregoing data writing steps further include recording writing counts for the writing units and determining whether the writing count for each writing unit is less than a predetermined threshold value, wherein the data is written only to the writing unit having the writing count less than the predetermined threshold value.

According to an embodiment of the present invention, the writing unit is a sector, a page or a block.

According to an embodiment of the present invention, the foregoing data writing steps further include performing an erase command through the non-volatile memory writing program to erase all the data recorded in the non-volatile memory.

According to an embodiment of the present invention, the non-volatile memory is a flash memory.

The present invention provides a controller adapted to a storage system having a non-volatile memory. The non-volatile memory has a plurality of writing units. The controller includes a non-volatile memory interface, a micro-processor unit and a write-protecting module. The micro-processor unit is used for identifying a write-enabling command and a write-protecting command of the non-volatile memory writing program. A non-volatile memory interface is coupled to the micro-processor unit and used for accessing the non-volatile memory. The write-protecting module is coupled to the micro-processor unit and used for initializing and executing write protection to prevent any writing operation in the non-volatile memory, temporarily disabling the write protection according to the write-enabling command, and enabling the write protection of the non-volatile memory according to the write-protecting command. The non-volatile memory writing program is executed through the host connected to the storage system. The micro-processor unit receives and manages the data desired to be written to the non-volatile memory and then writes the data in the writing units not yet recorded with data in a unit of one writing unit through the non-volatile memory interface after the write-protecting module temporarily disables the write protection.

According to an embodiment of the present invention, each of the foregoing writing units can only be written once.

According to an embodiment of the present invention, the micro-processor unit records writing counts for the writing units and determines whether the writing count for each writing unit is less than a predetermined threshold value, wherein the data is written only to the writing unit having the writing count less than the predetermined threshold value.

According to an embodiment of the present invention, the writing unit is a sector, a page or a block.

According to an embodiment of the present invention, the micro-processor unit erases all the data recorded in the non-volatile memory according to an erase command of the non-volatile memory writing program.

According to an embodiment of the present invention, the non-volatile memory is a flash memory.

In the present invention, a write-protecting mechanism is adopted to prevent a writing operation in the non-volatile memory and the writing operation can only be performed through the non-volatile memory writing program so that damage to the non-volatile memory due to multiple writings is avoided.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram illustrating a non-volatile storage system according to the first embodiment of the present invention.

FIG. 2 is a flowchart illustrating a data writing method according to the first embodiment of the present invention.

FIG. 3 is a partial flowchart illustrating a writing operation of the controller according to the first embodiment of the present invention.

FIG. 4 is a flowchart illustrating a data writing method according to the second embodiment of the present invention.

FIG. 5 is a partial flowchart illustrating a writing operation and an erasing operation of the controller according to the second embodiment of the present invention.

### DESCRIPTION OF EMBODIMENTS

In order to limit non-volatile memories originally designed to be repeatedly written and erased as “written once only” or “to be written for a specific number of times”, in the present invention, a software program is provided for the non-volatile memory storage system (e.g., a non-volatile memory writing program). When the user wants to write data to the non-volatile memory storage system, he/she has to execute this software program in host system in order to perform data writing. In addition, through coordination between the software program and the controller of the non-volatile memory storage system, a number of times of writing each writing unit in the non-volatile memory within the non-volatile memory storage system is limited. A plurality of embodiments accompanied with drawings is described in the following to illustrate the present invention in more detail. Wherever possible, the same reference numbers are used in the drawings and the description to refer to the same or like parts.

### First Embodiment

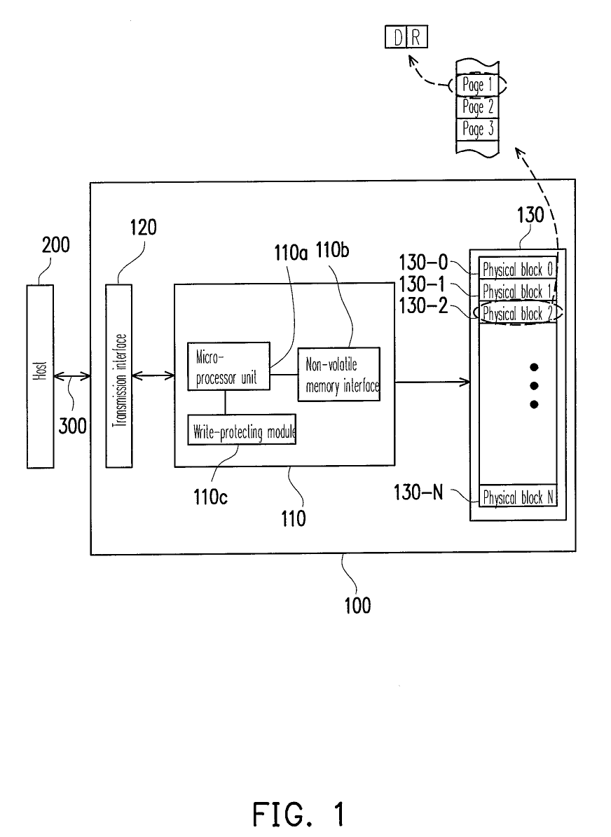

FIG. 1 is a schematic block diagram illustrating a non-volatile storage system according to the first embodiment of the present invention.

Referring to FIG. 1, a non-volatile memory storage system 100 includes a controller 110, a transmission interface 120 and a non-volatile memory 130. The non-volatile memory storage system 100 is usually used in a removable manner along with a host 200 and thus the host 200 can write data to the non-volatile memory storage system 100 or access data from the non-volatile memory storage system 100. In the present embodiment, the non-volatile memory storage system 100 is a memory card. However, it is to be understood that in another embodiment of the present invention, the non-volatile memory storage system 100 may also be a flash disk.

The controller 110 controls the overall operation of the transmission interface 120 and the non-volatile memory 130, such as storage, reading and erasure of data. The controller 110 includes a micro-processor unit 110a, a non-volatile memory interface 110b and a write-protecting module 110c.

The micro-processor unit 110a controls the operation of the non-volatile memory interface 110b and a write-protecting module 110c.

The non-volatile memory interface 110b is electrically connected to the micro-processor unit 110a and used for accessing the non-volatile memory 130. In other words, data desired to be written to the non-volatile memory 130 through the host 200 is converted to a format acceptable to the non-volatile memory 130 through the non-volatile memory interface 110b.

The write-protecting module 110c is electrically connected to the micro-processor unit 110a used for initializing and executing write protection to prevent any writing operation in the non-volatile memory 130.

Moreover, although not illustrated in the drawing accompanying the present embodiment, the controller 110 may further include some common function modules of a general flash memory controller, e.g., a buffer memory, a memory management module, an error correction module and a power management module.

The transmission interface 120 is connected to the host 200 through a bus 300. In the present embodiment, the transmission interface 120 is an SD interface. However, it is to be understood that the present invention is not limited to this example. The transmission interface 120 may be a USB interface, an IEEE 1394 interface, a SATA interface, an MS interface, an MMC interface, a PCI Express interface, a CF interface, an IDE interface or other suitable data transmission interfaces.

The non-volatile memory 130 is electrically connected to the controller 110 and used for storing data. In the present embodiment, the non-volatile memory 130 is a multi level cell (MLC) NAND flash memory. Nevertheless, it should be understood that the present invention is not limited to this example. In another embodiment of the present invention, a single level cell (SLC) NAND flash memory may also be applied to the present invention.

The non-volatile memory 130 is partitioned into a plurality of physical blocks 130-0˜130-N. Generally, a physical block in a flash memory is the minimum unit for erasure. In other words, each of the physical blocks has the minimum number of cells to be erased altogether. Each of the physical blocks is usually partitioned into a plurality of pages, e.g., 64 pages, 128 pages and 256 pages. A page is usually the minimum unit for programming, but it should be noted that in different flash memory designs, the minimum program unit may also be a sector. In other words, a page has a plurality of sectors and a sector is taken as the minimum unit for programming, that is, a page as the minimum unit for writing or reading data. Each page usually includes a user data area D and a redundant area R. The user data area D is used for storing data of the user and the redundant area R is used for storing systematic data, e.g., error correcting code (ECC). In order to correspond to the size of a sector in a disk driver, generally, the user data area D is 512 bytes and the redundant area R is 16 bytes, which means a page is a sector. However, a plurality of sectors may also form a page, such as a page including four sectors. In the present embodiment, a writing unit of the non-volatile memory 130 is a page. According to another embodiment of the present invention, the writing unit of the non-volatile memory 130 may also be designed as a block or a sector. It should be noted that each page or each block of the non-volatile memory 130 can only be repeatedly written for few times, e.g. 100 times. Therefore, in the present embodiment, the non-volatile memory storage system 100 is designed as can be “written once only”.

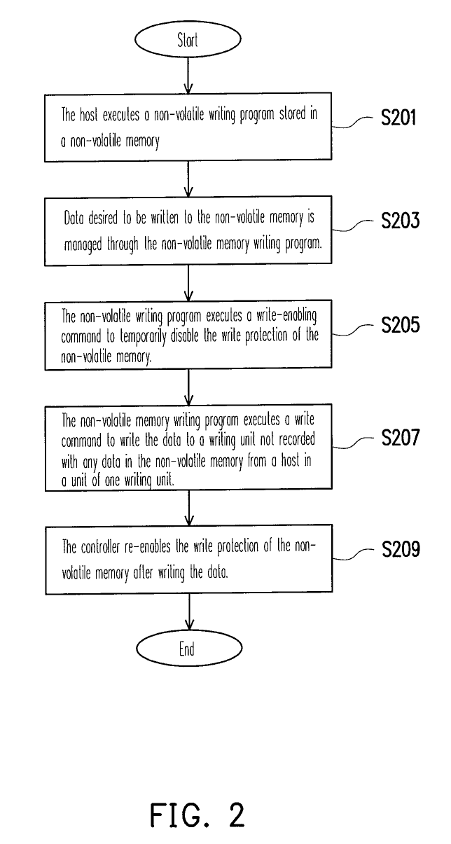

Particularly, according to the non-volatile memory storage system 100 in the present embodiment of the present invention, the write-protecting module 110c of the controller 110 is preset by default as avoiding being written in the non-volatile memory 130. Hence, according to the present embodiment of the present invention, the non-volatile memory storage system 100 further includes a non-volatile memory writing program (not illustrated). The non-volatile memory writing program is executed through the host 200 to complete the data writing steps according to the present embodiment. A write-enabling command and a write-protecting command of the non-volatile memory writing program can be identified by the micro-processor unit 110a of the controller 110. The write-protecting module 110c of the controller 110 can enable or disable the write protection of the non-volatile memory 130 according to the write-enabling command or the write-protecting command respectively. The aforesaid data writing steps later will be described in detail along with the accompanying FIG. 2. In other words, according to the present embodiment of the present invention, the non-volatile memory storage system 100 must execute the non-volatile memory writing program to write data.

In the present embodiment, the non-volatile memory writing program is stored in the same disk partition area in the non-volatile memory 130 along with data stored by the user. Nevertheless, in another embodiment of the present invention, a disk partition area may be partitioned from the non-volatile memory 130 to store the non-volatile memory writing program for the user of the host 200 to select and execute. Additionally, in another embodiment of the present invention, the non-volatile memory writing program as stored may also be set as read-only to prevent the user from deleting the program in error. Further, the program may also be independently stored in a storage medium so that the user may install the program in the host 200 or the non-volatile memory 130.

FIG. 2 is a flowchart illustrating a data writing method according to the first embodiment of the present invention.

Referring to FIG. 2, in a step S201, the user executes the non-volatile memory writing program stored in the non-volatile memory 130 via the host 200. Next, in a step S203, data desired to be written to the non-volatile memory 130 is managed through the non-volatile memory writing program (not illustrated). Management of the data desired to be written to the non-volatile memory 130 includes collecting the data as a writing unit and/or aligning a sequence of addresses to which the data is written. For example, the non-volatile memory writing program can display a Windows interface for the user to manage the data desired to be written to the non-volatile memory 130. It should be noted that in the present embodiment, the step of managing the data desired to be written to the non-volatile memory 130 is executed by the non-volatile memory writing program run in the host 200. However, in another embodiment of the present invention, the host 200 may also directly transmit the data to the controller 110 and the data desired to be written to the non-volatile memory 130 is managed by the controller 110.

Afterwards, when the user of the host 200 executes the non-volatile memory writing program to perform the write command, in a step S205 the non-volatile memory writing program executes the write-enabling command to temporarily disable the write protection of the non-volatile memory 130.

After disabling the write protection of the non-volatile memory 130, in a step S207 the non-volatile memory writing program executes a write command to write the data from the host 200 to the non-volatile memory 130 in a unit of one writing unit. In a step S209, the write-protecting module 110c of the controller 110 re-enables the write protection of the non-volatile memory 130 according to the write-protecting command of the non-volatile memory writing program after the data writing is completed.

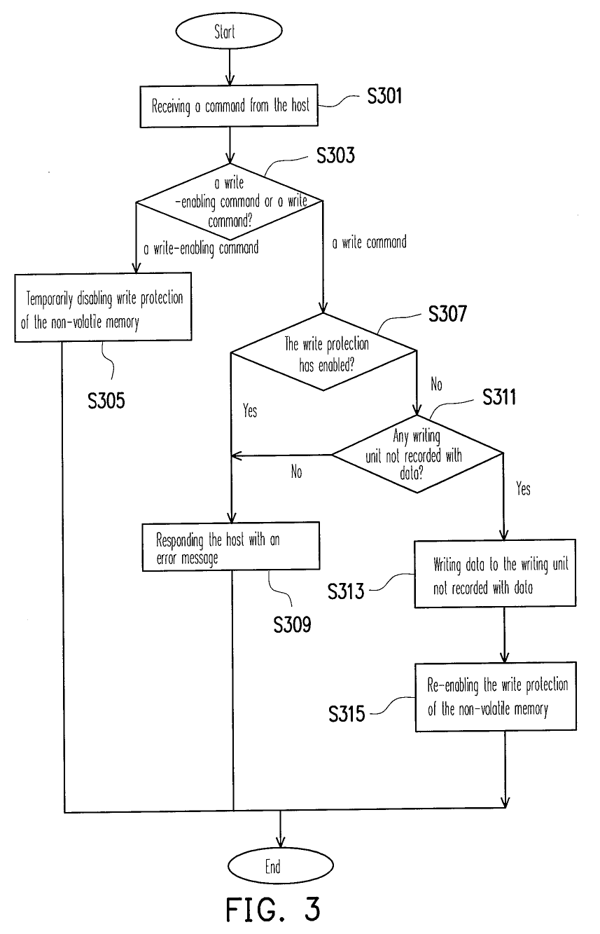

Moreover, in the present embodiment, since the writing units of the non-volatile memory 130 can only be written once, in the step S207 the controller 110 provides the writing units not yet recorded with any data in the non-volatile memory 130 for writing data. Specifically, in the step S207, the controller 110 may respond with an error message for notifying the host 200 that there is no space for writing data. A detailed description of the operation of the controller 110 is provided below along with the accompanying FIG. 3.

FIG. 3 is a partial flowchart illustrating a writing operation of the controller 110 according to the first embodiment of the present invention.

When the non-volatile memory storage system 100 is turned on, the controller 110 is in a standby status to receive a command from the host 200. Referring to FIG. 3, in a step S301, a command from the host 200 is received. Afterwards, in a step S303, the received command is determined as a write-enabling command or a general write command. If in the step S303 the received command is determined as a write-enabling command, the write protection of the non-volatile memory 130 will be temporarily disabled in a step S305.

If in the step S303 the received command is determined as a general write command, it will be determined in a step S307 whether the write protection of the non-volatile memory 130 has already been enabled. If in the step S307 the write protection of the non-volatile memory 130 is determined as already enabled, in a step S309 the host 200 will be responded with an error message. If in the step S307 the write protection of the non-volatile memory 130 is determined as not enabled yet, it will be determined in a step S311 whether there is still any writing unit not yet recorded with data in the non-volatile memory 130. If in the step S311 it is determined that there is a writing unit not recorded with data in the non-volatile memory 130, in a step S313 the data will be written to the writing unit not recorded with data and in a step S315 the write protection of the non-volatile memory 130 will be re-enabled. If in the step S311 it is determined that there is no writing unit not recorded with data in the non-volatile memory 130, the step S309 will be executed.

### Second Embodiment

A framework of the non-volatile memory storage system according to the second embodiment of the present invention is the same as that of the first embodiment (illustrated as FIG. 1) and is therefore not to be reiterated herein. The difference between the second embodiment and the first embodiment lies in that a writing procedure of the non-volatile memory storage system in the second embodiment allows repeated writing for a pre-defined number of times (i.e. a predetermined threshold value) in the writing units of the non-volatile memory. Here, the predetermined threshold value may be set by a manufacturer according to the quality of the non-volatile memory.

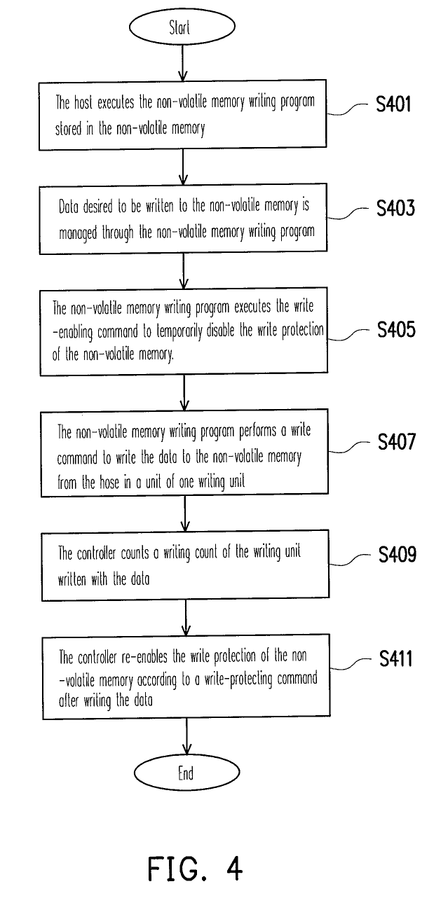

FIG. 4 is a flowchart illustrating a data writing method according to the second embodiment of the present invention.

Referring to FIG. 4, in a step S401, the user executes the non-volatile memory writing program stored in the non-volatile memory 130 through the host 200. Next, in a step S403, data desired to be written to the non-volatile memory 130 are managed through the non-volatile memory writing program.

Thereafter, when the user of the host 200 executes the non-volatile memory writing program to perform the write command, in a step S405 the non-volatile memory writing program executes the write-enabling command to temporarily disable the write protection of the non-volatile memory 130.

After disabling the write protection of the non-volatile memory 130, in a step S407 the non-volatile memory writing program executes a write command to write the data from the host 200 to the non-volatile memory 130 in a unit of one writing unit. In a step S409 the controller 110 counts by counting the writing count of the writing unit written with the data, for example, adding 1 to the writing count. The writing count is used for recording a number of times of writing data. For example, in the present embodiment, the writing count is recorded in the redundant area R of each of the writing units. However, it should be understood that the present invention is not limited to this example.

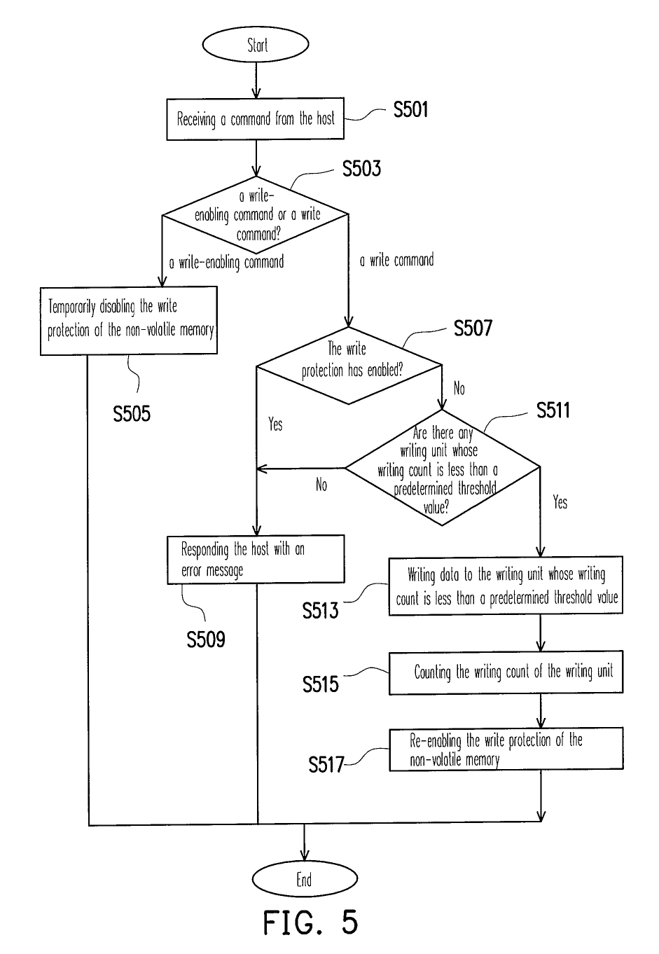

Finally, in a step S411 the controller 110 re-enables the write protection of the non-volatile memory 130 according to the write-protecting command of the non-volatile memory writing program. It is noted in the present embodiment that since the writing units of the non-volatile memory 130 can be written only for a predetermined number of times, in the step S407 the controller 110 provides the writing unit having the writing count less than the predetermined threshold value in the non-volatile memory 130 for writing data. Specifically, in the step S407, the controller 110 may respond with an error message for notifying the host 200 that there is no space for writing data. A detailed description of the operation of the controller 110 is provided below along with the accompanying FIG. 5.

FIG. 5 is a partial flowchart of a writing operation and an erasing operation of the controller 110 according to the second embodiment of the present invention.

When the non-volatile memory storage system 100 is turned on, the controller 110 is in a standby status to receive a command from the host 200. Referring to FIG. 5, in a step S501, a command from the host 200 is received. Afterwards, in a step S503, the received command is determined as a write-enabling command or a general write command. If in the step S503 the received command is determined as a write-enabling command, in a step S505 the write protection of the non-volatile memory 130 will be temporarily disabled.

If in the step S503 the received command is determined as a general write command, it will be determined in a step S507 whether the write protection of the non-volatile memory 130 has already been enabled. If in the step S507 the write protection of the non-volatile memory 130 is determined as already enabled, in a step S509 the host 200 will be responded with an error message. If in the step S507 the write protection of the non-volatile memory 130 is determined as not yet enabled, it will be determined in a step S511 whether there is any writing unit having the writing count less than a predetermined threshold value in the non-volatile memory 130. If in the step S511 there exists a writing unit having the writing count less than a predetermined threshold value, in a step S513 the data will be written to the writing unit not recorded with any data and in a step S515 the writing count of the writing unit being written will be counted, e.g., adding 1 to the writing count. Finally, in a step S517 the write protection of the non-volatile memory 130 is re-enabled. If in the step S511 it is determined there is no writing unit having the writing count less than the predetermined threshold value in the non-volatile memory 130, the step S509 is executed.

According to another embodiment of the present invention, the foregoing data writing steps further include performing an erase command through the non-volatile memory writing program to erase all the data recorded in the non-volatile memory 130.

In summary, a write-protecting mechanism is provided in the present invention to control a number of times of writing a non-volatile memory. Data is written to the non-volatile memory through executing the non-volatile memory writing program and thus the data is written in batches and the number of times of writing is limited so that the non-volatile memory designed for few times of writing only is prevented from being damaged by frequent writing of small amounts of data. Through developing this non-volatile memory writing procedure, defective flash memories produced during the process which can be written for only few times are effectively utilized. As a result, use of originally defective goods is improved and thereby reducing production costs.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data writing method, adapted to a non-volatile memory having a plurality of writing units, the data writing method comprising:
executing a non-volatile memory writing program;
managing data desired to be written to the non-volatile memory through the non-volatile memory writing program;
executing a write-enabling command through the non-volatile memory writing program to temporarily disable a write protection of the non-volatile memory;
executing a write command through the non-volatile memory writing program to write the data from a host to the writing unit not recorded with any data in the non-volatile memory in a unit of one writing unit; and
executing a write-protecting command through the non-volatile memory writing program after writing the data to enable the write protection of the non-volatile memory.

2. The data writing method as claimed in claim 1, wherein each of the writing units can only be written once.

3. The data writing method as claimed in claim 1, further comprising:
recording writing counts for the writing units; and
determining whether the writing count for each of the writing units is less than a predetermined threshold value,
wherein the data is written only to the writing unit having the writing count less than the predetermined threshold value.

4. The data writing method as claimed in claim 1, wherein each of the writing units is a sector, a page or a block.

5. The data writing method as claimed in claim 1, further comprising executing an erase command through the non-volatile memory writing program to erase all the data recorded in the non-volatile memory.

6. The data writing method as claimed in claim 1, wherein the step of managing the data desired to be written to the non-volatile memory comprises performing at least one of a collecting operation and an aligning operation on the data.

7. A non-volatile memory storage system, comprising:
a transmission interface used for connecting to a host;
a non-volatile memory having a plurality of writing units for storing data;
a non-volatile memory writing program executed through the host to perform a plurality of data writing steps; and
a controller electrically connected to the transmission interface and the non-volatile memory and used for initializing and executing a write protection of the non-volatile memory, identifying a write-enabling command of the non-volatile memory writing program to disable the write protection of the non-volatile memory, and identifying a write-protecting command of the non-volatile memory writing program to enable the write protection of the non-volatile memory,
wherein the data writing steps comprise managing data desired to be written to the non-volatile memory, executing the write-enabling command, executing a write command to write the data from the host to the writing unit not recorded with any data in the non-volatile memory in a unit of one writing unit, and executing the write-protecting command.

8. The non-volatile memory storage system as claimed in claim 7, wherein each of the writing units can only be written once.

9. The non-volatile memory storage system as claimed in claim 7, wherein the data writing steps further comprise:
recording writing counts for the writing units; and
determining whether the writing count for each of the writing units is less than a predetermined threshold value,
wherein the data is written only to the writing unit having the writing count less than the predetermined threshold value.

10. The non-volatile memory storage system as claimed in claim 7, wherein each of the writing units is a sector, a page or a block.

11. The non-volatile memory storage system as claimed in claim 7, wherein the data writing steps further comprise executing an erase command through the non-volatile memory writing program to erase all the data recorded in the non-volatile memory.

12. The non-volatile memory storage system as claimed in claim 7, wherein the non-volatile memory writing program is stored in the non-volatile memory.

13. The non-volatile memory storage system as claimed in claim 7, wherein the non-volatile memory is a flash memory.

14. The non-volatile memory storage system as claimed in claim 7, wherein the transmission interface is a PCI Express interface, a USB interface, an IEEE 1394 interface, a SATA interface, an MS interface, an MMC interface, an SD interface, a CF interface or an IDE interface.

15. The non-volatile memory storage system as claimed in claim 7, wherein the non-volatile memory writing program is stored in an independent partition area of the non-volatile memory.

16. The non-volatile memory storage system as claimed in claim 7, wherein the step of managing the data desired to be written to the non-volatile memory comprises performing at least one of a collecting operation and an aligning operation on the data.

17. A controller, adapted to a storage system having a non-volatile memory, wherein the non-volatile memory has a plurality of writing units, the controller comprising:
a micro-processor unit used for identifying a write-enabling command and a write-protecting command of a non-volatile memory writing program;
a non-volatile memory interface electrically connected to the micro-processor unit and used for accessing the non-volatile memory; and
a write-protecting module electrically connected to the micro-processor unit and used for initializing and executing a write protection to prevent any writing operation on the non-volatile memory, temporarily disabling the write protection according to the write-enabling command, and enabling the write protection of the non-volatile memory according to the write-protecting command,
wherein the non-volatile memory writing program is executed through a host connected to the storage system to perform a plurality of data writing steps, the data writing steps comprising managing data desired to be written to the non-volatile memory, executing the write-enabling command, executing a write command to write the data from the host to the writing unit not recorded with any data through the micro-processor unit and the non-volatile memory interface in a unit of one writing unit, and executing the write-protecting command.

18. The controller as claimed in claim 17, wherein each of the writing units can only be written once.

19. The controller as claimed in claim 17, wherein the data writing steps further comprise:
recording writing counts for the writing units; and
determining whether the writing count for each of the writing units is less than a predetermined threshold value,
wherein the data is written only to the writing unit having the writing count less than the predetermined threshold value.

20. The controller as claimed in claim 17, wherein each of the writing units is a sector, a page or a block.

21. The controller as claimed in claim 17, wherein the data writing steps further comprise executing an erase command through the non-volatile memory writing program to erase all the data recorded in the non-volatile memory.

22. The controller as claimed in claim 17, wherein the non-volatile memory is a flash memory.

23. A controller, adapted to a storage system having a non-volatile memory, wherein the non-volatile memory has a plurality of writing units, the controller comprising:
a micro-processor unit used for identifying a write-enabling command and a write-protecting command of a non-volatile memory writing program;
a non-volatile memory interface electrically connected to the micro-processor unit and used for accessing the non-volatile memory; and
a write-protecting module electrically connected to the micro-processor unit and used for initializing and executing a write protection to prevent any writing operation on the non-volatile memory, temporarily disabling the write protection according to the write-enabling command, and enabling the write protection of the non-volatile memory according to the write-protecting command,
wherein the non-volatile memory writing program is executed by a host connected to the storage system and the micro-processor unit receives and manages data desired to be written to the non-volatile memory from the host and writes the data to the writing unit not recorded with any data through the non-volatile memory interface in a unit of one writing unit after the write-protecting module temporarily disables the write protection.

24. The controller as claimed in claim 23, wherein each of the writing units can only be written once.

25. The controller as claimed in claim 23, wherein the micro-processor unit records writing counts for the writing units, determines whether the writing count for each of the writing units is less than a predetermined threshold value and writes the data only to the writing unit having the writing count less than the predetermined threshold value.
